(19) United States
(12) Patent Application Publication
(10) Pub. No.: US 2026/0104062 A1
(43) Pub. Date: Apr. 16, 2026

(54) HYDRAULIC CIRCUIT USING A PRESSURE ADAPTER

(71) Applicant: POCLAIN HYDRAULICS INDUSTRIE, Verberie (FR)

(72) Inventors: Gilles Lemaire, Verberie (FR); Bastien Clapit, Verberie (FR); Paul Fournet, Verberie (FR); Yoann Rousseau, Verberie (FR); Julien Viard, Verberie (FR); Pierre Bernard, Verberie (FR); Hubert Demailly, Verberie (FR); Vincent Langlois, Verberie (FR); Joël Lefevre, Verberie (FR)

(73) Assignee: POCLAIN HYDRAULICS INDUSTRIE, Verberie (FR)

(21) Appl. No.: 19/114,064

(22) PCT Filed: Sep. 22, 2023
(86) PCT No.: PCT/FR2023/051461

§ 371 Date: Mar. 21, 2025

(30) Foreign Application Priority Data
Sep. 22, 2022 (FR) FR2209598

(51) Int. Cl. F15B 11/032; F16H 61/4008; F16H 61/4035

(52) U.S. Cl. CPC F15B 11/032; F16H 61/4008; F16H 61/4035; F15B 2211/20546; F15B 2211/7058

(57) ABSTRACT

A hydraulic circuit for driving a two-way hydraulic actuator (200)
a hydraulic energy source (100),
a hydraulic actuator (200),
a pressure-adapting module (3000),
a first supply line connecting a first terminal of the hydraulic energy source (100) to a first port of the pressure-adapting module (3000)
a second supply line connecting a second terminal of the hydraulic energy source (100) to a second port of the pressure-adapting module (3000)
a first adapting line connecting the pressure-adapting module (3000) to a first terminal of the hydraulic actuator (230)
a second adapting line connecting the pressure-adapting module (3000) to the other terminal of the hydraulic actuator (230), the pressure-adapting module being suitable for modifying the pressure difference across the terminals of the hydraulic actuator (230) in such a way that the pressure difference across the terminals of the hydraulic actuator (230) is different from the pressure difference across the terminals of the hydraulic energy source (100).

### TECHNICAL FIELD

This invention relates to a hydraulic circuit comprising a pressure adapter, particularly for driving axles, mover members, cylinders, or for rotationally driving more generic items of equipment such as a hoist, a grinder, or a drill.

### Prior Art

Hydraulic systems are usually composed of a power-transforming machine which converts the mechanical energy provided by a primary motor, for example a thermal engine or an electric motor, into hydraulic energy distributed by a network of high-pressure ducts, to one or more hydraulic members such as cylinders or hydraulic motors driving wheels or axles.

This transmission solution does however have certain limitations, in particular:
On torque density: the pressure of the pipes commonly used being limited to values of less than 450 bar, the maximum transmissible torque limit is the product of this pressure and of the value of the displacement of a hydraulic actuator, typically of hydraulic motors. However, the displacement value directly affects the dimensions of the motors, as well as their cost.
On speed: for a given pump displacement and maximum speed of the primary motor, a maximum flow rate is defined. In the case of an application for a transmission, this then limits the speed of the vehicle.

In the case of a hydrostatic transmission, a distinction is typically made between two very distinct operating modes:
An operating mode that will be described as a “work” mode: the load is significant and the speed is low. Here one is seeking the best gradability (for a vehicle) or in any case the greatest torque (for a more generic item of rotating equipment), this particular condition is a determining factor for the dimensioning of the displacement of the motor.
An operating mode that will be described as “road” mode for a vehicle or “normal” mode for a more generic item of rotating equipment, particularly for the movement of the vehicle or of the item of machinery between two work sites: in the latter, the load is low, and the speed is high. Here one is seeking to reach the fastest speed, which will be limited by the size and the bulk of the pumps and/or of the motors driving the pumps.

It will therefore be understood that these two operating modes restrict the dimensioning of the hydraulic circuit; the components must be overdimensioned to offer a power margin that is never used by the vehicle driver.

More generally, for the driving of a hydraulic member, different driving modes may be required involving very varied requirements in terms of supply of hydraulic power.

To palliate these problems the use has been envisioned, within a hydraulic circuit, of pressure/flow rate adapters which can be enabled or disabled on demand in order to dimension the hydraulic circuit to the more normal conditions of use, while allowing an intermittent operation over more unusual ranges of use.

However when the hydraulic consumer is two-way it is beneficial to be able to make provision for a circuit operation in four quadrants (first quadrant: the consumer drives an action in one direction; second quadrant: the consumer restrains an action in this direction; third quadrant: the consumer drives an action in the other direction; fourth quadrant: the consumer restrains an action in this other direction) which allows the pressure adaptation.

### SUMMARY OF THE INVENTION

To at least partially meet these issues, this invention relates to a hydraulic circuit for driving a two-way hydraulic actuator having two terminals, said circuit comprising
a hydraulic energy source suitable for delivering a flow through the hydraulic circuit, thus in particular making it possible to raise the pressure in the hydraulic circuit,
a hydraulic actuator,
a pressure-adapting module,
a first supply line connecting a first terminal of the hydraulic energy source to a first port of the pressure-adapting module
a second supply line connecting a second terminal of the hydraulic energy source to a second port of the pressure-adapting module
a first adapting line connecting the pressure-adapting module to a first terminal of the hydraulic actuator
a second adapting line connecting the pressure-adapting module to the other terminal of the hydraulic actuator,
the pressure-adapting module being suitable for modifying the pressure difference across the terminals of the hydraulic actuator in such a way that the pressure difference across the terminals of the hydraulic actuator is different from the pressure difference across the terminals of the hydraulic energy source.

According to an example, the first supply line, the second supply line, the first adapting line and the second adapting line are separate.

The circuit is typically a closed-loop hydraulic circuit.

According to an example, the circuit further comprises a first bypass line connecting a first terminal of the hydraulic energy source to the first terminal of the hydraulic actuator, and a second bypass line connecting a second terminal of the hydraulic energy source to the second terminal of the hydraulic actuator, said first bypass line and second bypass line being equipped with closing means suitable for selectively closing off said first bypass line and second bypass line.

According to an example, the pressure-adapting module is suitable for increasing the pressure difference across the terminals of the hydraulic actuator in such a way that the pressure difference across the terminals of the hydraulic actuator is greater than the pressure difference across the terminals of the hydraulic energy source.

According to an example, the pressure-adapting module is suitable for allowing the reduction of the flow rate traversing the hydraulic actuator in such a way that the flow rate traversing the hydraulic actuator is less than the flow rate supplied by the hydraulic energy source.

According to an example, the pressure-adapting module is suitable for reducing the pressure difference across the terminals of the hydraulic actuator in such a way that the pressure difference across the terminals of the hydraulic actuator is less than the pressure difference across the terminals of the hydraulic energy source.

According to an example, the pressure-adapting module is suitable for allowing the increasing of the flow rate traversing the hydraulic actuator in such a way that the flow rate traversing the hydraulic actuator is greater than the flow rate supplied by the hydraulic energy source.

According to an example, the pressure-adapting module comprises a pressure adapter comprising a first hydraulic machine and a second hydraulic machine rotationally secured to one another, said first and second hydraulic machines being configured such that one has the operation of a pump and the other has the operation of a motor.

According to an example, the pressure-adapting module comprises a single pressure adapter.

According to an example, the first hydraulic machine has a first terminal connected to the first terminal of the hydraulic energy source, and a second terminal connected to the second terminal of the hydraulic energy source, and the second hydraulic has a first terminal connected to the first terminal of the hydraulic actuator, and a second terminal connected to the second terminal of the hydraulic actuator.

According to an example,
the first hydraulic machine has a first terminal and a second terminal,
the second hydraulic has a first terminal and a second terminal,
the first terminal of the first hydraulic machine is connected to the first terminal of the hydraulic energy source,
the second terminal of the second hydraulic machine is connected to the first terminal of the hydraulic actuator,
the second terminal of the first hydraulic machine is connected to the first terminal of the second hydraulic machine, and to the second terminal of the hydraulic energy source.

According to an example, the second terminal of the first hydraulic machine is connected to the first terminal of the second hydraulic machine, and to the first terminal and to the second terminal of the hydraulic energy source via a low-pressure selector.

According to an example, the low-pressure selector is housed in a casing of the pressure-adapting module. By being housed in the same casing, the ducts connecting the low-pressure selector to the first hydraulic machine and to the second hydraulic machine may be formed directly in the casing.

According to an example, the second terminal of the second hydraulic machine is connected to the first terminal and to the second terminal of the hydraulic actuator via a high-pressure selector.

According to an example, the high-pressure selector is housed in a casing of the pressure-adapting module. By being housed in the same casing, the ducts connecting the low-pressure selector to the first hydraulic machine and to the second hydraulic machine may be formed directly in the casing.

According to an example, the circuit has:
a first operating mode, wherein the hydraulic actuator is supplied in such a way as to deliver mechanical power along a first direction of operation,
a second operating mode, wherein the hydraulic actuator delivers a hydraulic power along the first direction of operation,
a third operating mode, wherein the hydraulic actuator is supplied in such a way as to deliver a mechanical power along a second direction of operation opposed to the first direction of operation, and
a fourth operating mode, wherein the hydraulic actuator delivers a hydraulic power along the second direction of operation.

According to an example, when the hydraulic actuator is an actuator suitable for transforming hydraulic energy into mechanical energy or conversely, and configured in such a way that a reversal of the pressure difference across its terminals causes a change of direction of actuation.

According to an example, the pressure booster is configured to be engaged when the highest of the two pressures between the first supply line and the second supply line exceeds a threshold value.

This summary also has a system for driving a member by means of a hydraulic circuit, comprising:
a hydraulic energy source suitable for delivering a pressure in the hydraulic circuit,
a drive member, comprising:
a casing, having a first orifice and a second casing orifice suitable for defining an intake and a discharge of the casing,
a primary hydraulic machine, suitable for being supplied by the hydraulic energy source, the primary hydraulic machine being housed in the casing and having a first hydraulic machine orifice and a second hydraulic machine orifice, said system being characterized in that the drive member comprises a pressure booster incorporated into the casing,
said pressure booster being suitable for selectively raising the pressure, in such a way that the pressure difference between the two orifices of the primary hydraulic machine is greater than the pressure difference between the two orifices of the casing.

According to an example, the pressure booster is incorporated into the casing in such a way that the pressure booster is connected to the first orifice and to the second orifice of the primary hydraulic machine via ducts formed in the casing.

According to an example, the pressure booster is configured to be engaged when the pressure difference between the two orifices of the primary hydraulic machine exceeds a threshold value.

The system may further comprise at least one valve connecting the pressure booster to the first orifice and/or to the second orifice of the casing, said at least one valve being configured to disengage the pressure booster when the pressure difference between the two orifices of the casing is less than or equal to a threshold pressure value.

The system may further comprise at least one valve connecting the pressure booster to the first orifice and/or to the second orifice of the casing, said at least one valve being configured to disengage the pressure booster when the rotation speed of the primary hydraulic machine is greater than a threshold value.

The system may further comprise at least one valve connecting the pressure booster to the first orifice and/or to the second orifice of the casing, said at least one valve being configured to disengage the pressure booster when the rotation speed of the primary hydraulic machine exceeds a certain threshold.

According to an example, the pressure booster is suitable for drawing a flow rate Q1 and a pressure P1 at the first or at the second orifice of the casing, and delivering a flow rate Q2 and a pressure P2 at the first or at the second orifice of the primary hydraulic machine, such that Q2<Q1 and P2>P1.

According to an example the primary hydraulic machine can be a hydraulic machine of axial technology, for example particularly having an inclined platform on which the pistons slide.

According to an example the primary hydraulic machine can be a hydraulic machine of radial technology, for example particularly having a multilobe cam in contact with which the pistons slide.

According to an example the primary hydraulic machine can be a fixed-displacement machine.

According to an example the primary hydraulic machine can be a multi-displacement machine.

According to an example the primary hydraulic machine can be a variable-displacement or continuously variable-displacement machine.

According to an example, the pressure booster is of oscillating linear technology.

According to an example, the pressure booster comprises a first hydraulic machine and a second hydraulic machine rotationally secured to one another, the first hydraulic machine and the second hydraulic machine having identical displacements, said first and second hydraulic machines being configured such that one has the operation of a pump and the other has the operation of a motor.

According to an example, the pressure booster comprises a first hydraulic machine and a second hydraulic machine rotationally secured to one another, the first hydraulic machine and the second hydraulic machine having different displacements, said first and second hydraulic machines being configured such that one has the operation of a pump and the other has the operation of a motor.

According to an example, the pressure booster comprises a first hydraulic machine and a second hydraulic machine rotationally secured to one another, the first hydraulic machine and the second hydraulic machine having different displacements, said first and second hydraulic machines being configured such that one has the operation of a pump and the other has the operation of a motor. Said machines can be hydraulic machines of radial technology, and particularly of multi-lobe cam radial technology.

According to an example, the pressure booster comprises a first hydraulic machine and a second hydraulic machine rotationally secured to one another, said first and second hydraulic machines being configured such that one has the operation of a pump and the other has the operation of a motor. Said hydraulic machines can be fixed-displacement, multi-displacement or variable displacement machines.

According to an example,
the first hydraulic machine has a first orifice and a second orifice, the first orifice being selectively connected to the orifice of the casing having the highest pressure from among the two orifices of the casing, and the second orifice being selectively connected to the orifice of the casing having the lowest pressure from among the two orifices of the casing,
the second hydraulic machine has a first orifice and a second orifice, the first orifice being connected to the orifice of the casing having the lowest pressure from among the two orifices of the casing, and the second orifice being connected to the orifice of the primary hydraulic machine having the highest pressure via ducts fashioned in the casing.

According to an example, the pressure booster comprises a first hydraulic machine and a second hydraulic machine rotationally secured to one another, the first hydraulic machine having a greater displacement than the second hydraulic machine,
said system being configured such that, for a first operating mode, the first hydraulic machine has the operation of a motor, and the second hydraulic machine has the operation of a pump, said second hydraulic machine supplying the primary hydraulic machine.

According to an example,
the first hydraulic machine has a first orifice and a second orifice, the first orifice being selectively connected to the orifice of the casing having the highest pressure from among the two orifices of the casing, and the second orifice being selectively connected to the orifice of the casing having the lowest pressure from among the two orifices of the casing,
the second hydraulic machine has a first orifice and a second orifice, the first orifice being connected to the second orifice of the first hydraulic machine, and the second orifice being connected to the inner orifice of the primary hydraulic machine having the highest pressure via ducts fashioned in the casing.

According to an example, the second orifice of the second hydraulic machine is connected to the first orifice and to the second orifice of the primary hydraulic machine via a high-pressure selector.

According to an example,
the first orifice of the first hydraulic machine is connected to a first tared valve, connected on the one hand to the first casing orifice and on the other hand to the second casing orifice, said first tared valve being configured to connect the first orifice of the first hydraulic machine to the connections related to the hydraulic energy source having the highest pressure when the pressure difference between the orifices of the casing exceeds a first threshold taring value,
the second orifice of the first hydraulic machine is connected to a second tared valve, connected on the one hand to the first casing orifice and on the other hand to the second casing orifice, said second tared valve being configured to connect the first orifice of the first hydraulic machine to the connections related to the hydraulic energy source having the lowest pressure when the pressure difference between the orifices of the casing exceeds a second threshold taring value.

According to an example, the pressure booster comprises a first hydraulic machine and a second hydraulic machine rotationally secured to one another, the first hydraulic machine having a greater displacement than the second hydraulic machine,
said system being configured such that, for a first operating mode, the first hydraulic machine has the operation of a motor, and the second hydraulic machine has the operation of a pump, said second hydraulic machine supplying the primary hydraulic machine,
wherein
the first hydraulic machine has a first orifice and a second orifice, the first orifice being connected to the first orifice of the casing, and the second orifice being connected to the second orifice of the casing,
the second hydraulic machine has a first orifice and a second orifice, the first orifice being connected to the second orifice of the primary hydraulic machine, and the second orifice being connected to the first orifice of the primary hydraulic machine,
the system comprising a valve suitable for selectively isolating the first orifice of the casing from the first orifice of the primary hydraulic machine, and a valve suitable for selectively isolating the second orifice of the casing from the second orifice of the primary hydraulic machine.

According to an example, the first hydraulic machine and/or the second hydraulic machine are hydraulic machines with radial pistons and multilobe cam.

According to an example, at least one from among the first hydraulic machine and the second hydraulic machine is a variable-displacement hydraulic machine.

According to an example, the system further comprises a first valve and a second valve, the first valve being suitable for selectively connecting or isolating the first casing orifice to or from the first orifice of the primary hydraulic machine, and the second valve being suitable for selectively connecting or isolating the second casing orifice to or from the second orifice of the primary hydraulic machine.

According to an example, the pressure amplification is controlled by a controller external to the drive member.

According to an example, the primary hydraulic machine is a hydraulic machine with radial pistons and multilobe cam.

This summary also relates to a wheeled machine, for example a vehicle, a piece of building site machinery or a piece of agricultural machinery, comprising at least one mover member and at least one system as defined previously suitable for selectively rotationally driving said mover member.

This summary also relates to a drive member as defined previously with reference to the system. The invention thus in particular relates to a drive member suitable for selectively rotationally driving a member, the drive member, comprising:
a casing, having a first orifice and a second casing orifice suitable for defining an intake and a discharge of the casing,
a primary hydraulic machine, suitable for being supplied by a hydraulic energy source, the primary hydraulic machine being housed in the casing and having a first hydraulic machine orifice and a second hydraulic machine orifice, said system being characterized in that the drive member comprises a pressure booster incorporated into the casing,
said pressure booster being suitable for selectively raising the pressure, in such a way that the pressure difference between the two orifices of the primary hydraulic machine is greater than the pressure difference between the two orifices of the casing.

### BRIEF DESCRIPTION OF THE DRAWINGS

The invention and its advantages will be better understood on reading the following description given below of different embodiments of the invention given by way of non-limiting example.

FIG. 1 is a schematic view of an example of a system according to an aspect of the invention.

FIG. 2 shows an exemplary embodiment of a system according to an aspect of the invention.

FIG. 3 shows an exemplary embodiment of a system according to an aspect of the invention.

FIG. 4 shows another exemplary embodiment of a system according to an aspect of the invention.

FIG. 5 shows another exemplary embodiment of a system according to an aspect of the invention.

FIG. 6 shows another exemplary embodiment of a system according to an aspect of the invention.

FIG. 7 shows another exemplary embodiment of a system according to an aspect of the invention.

FIG. 8 shows a particular configuration of FIG. 6.

FIG. 9 shows a particular configuration of FIG. 6.

FIG. 10 shows another exemplary embodiment of a system according to an aspect of the invention.

FIG. 11 shows a particular configuration of the system shown on FIG. 10.

FIG. 12 shows another particular configuration of the system shown on FIG. 10.

FIG. 13 shows another particular configuration of the system shown on FIG. 10.

FIG. 14 shows another exemplary embodiment of a system according to an aspect of the invention.

FIG. 15 shows a particular configuration of the system shown on FIG. 14.

FIG. 16 shows another particular configuration of the system shown on FIG. 14.

FIG. 17 shows another particular configuration of the system shown on FIG. 14.

FIG. 18 shows another exemplary embodiment of a system according to an aspect of the invention.

FIG. 19 shows another exemplary embodiment of a system according to an aspect of the invention.

FIG. 20 shows another exemplary embodiment of a circuit according to an aspect of the invention.

FIG. 21 shows another exemplary embodiment of a circuit according to an aspect of the invention.

On all the figures, elements in common are marked by identical reference numbers.

### DESCRIPTION OF THE EMBODIMENTS

Below is a description of a system according to an aspect of the invention with reference to the figures. The circuits shown are simplified diagrams. Thus, different elements such as charging means and taring means are not shown on the figures. Those skilled in the art will however understand that the figures are not limiting, and that the circuits may comprise such well-known elements. In particular, in the embodiments described the member 10 is shown as a hydraulic motor intended to rotationally drive an element such as a wheel. However, the invention is applicable to other types of drive member, in particular translational drive members such as hydraulic cylinders.

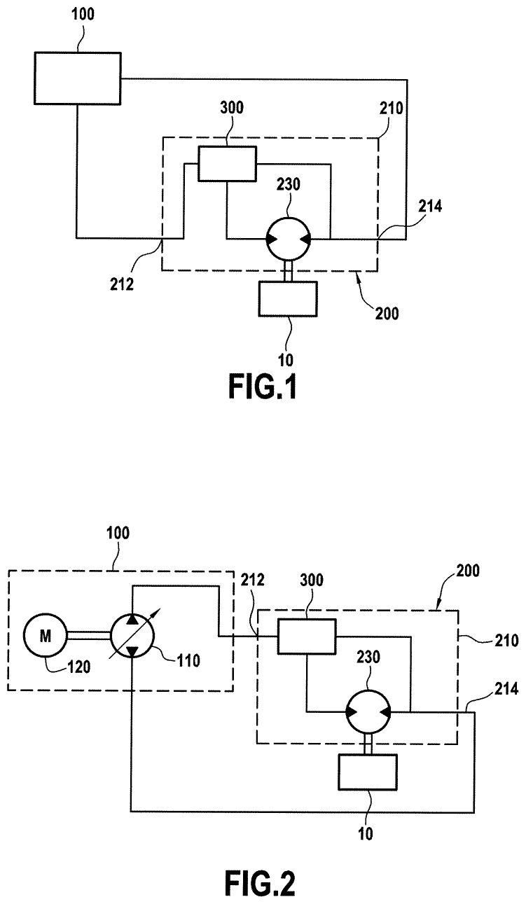

FIG. 1 is a schematic general view of a system according to an aspect of the invention. This figures shows a member 10, for example a moving member of a vehicle or of an item of machinery such as a wheel, a mechanical axle or an excavator turret slewing ring. This member 10 is driven by a hydraulic circuit.

The hydraulic circuit as shown comprises a hydraulic energy source 100, for example a source of flow such as a pump or an accumulator, and a drive member 200. The hydraulic energy source 100 is suitable for supplying the drive member 200, in such a way that the drive member drives the member 10 rotationally or translationally according to the type of member chosen. The circuit can be an open-loop or closed-loop hydraulic circuit. In the case of an open-loop hydraulic circuit, the hydraulic energy source 100 typically comprises a reservoir at ambient pressure, a hydraulic pump or an accumulator and a valve providing the hydraulic connection according to the operating mode. Conversely, a closed-loop hydraulic circuit refers to a hydraulic circuit in which the fluid does not go back into the reservoir. Thus, by considering a hydraulic pump as a source of flow, the fluid delivered by the pump flows through the circuit by traversing various actuators and hydraulic members, then returns to the pump without passing through a reservoir.

It will be understood that the system can be reversible. The description also generally has an operation in which the member 10 is rotationally driven. Since the hydraulic members have a reversible operation, a reverse operation is possible, particularly during braking phases: the member 10 then fulfils a drive function allowing the recovery of energy.

The hydraulic energy source 100 is typically a hydraulic pump, for example a variable-displacement hydraulic pump 110 driven by a primary motor 120 such as a thermal engine or an electric motor. The hydraulic energy source may also comprise a fixed-displacement hydraulic pump 110 and a primary motor 120 suitable for rotationally driving it at a variable speed. An exemplary embodiment (with a variable-displacement pump) is illustrated on FIG. 2.

The drive member 200 comprises a casing 210 in which is housed a primary hydraulic machine 230 typically suitable for operating as a motor to rotationally drive the member 10. The drive member also comprises a pressure booster 300 housed in the casing 210.

The pressure booster 300 is configured to selectively fulfil a function of boosting or amplifying pressure. Thus for an initial pressure P1 at the intake of the pressure booster 300, the pressure booster 300 will deliver a pressure P2 such that P2>P1.

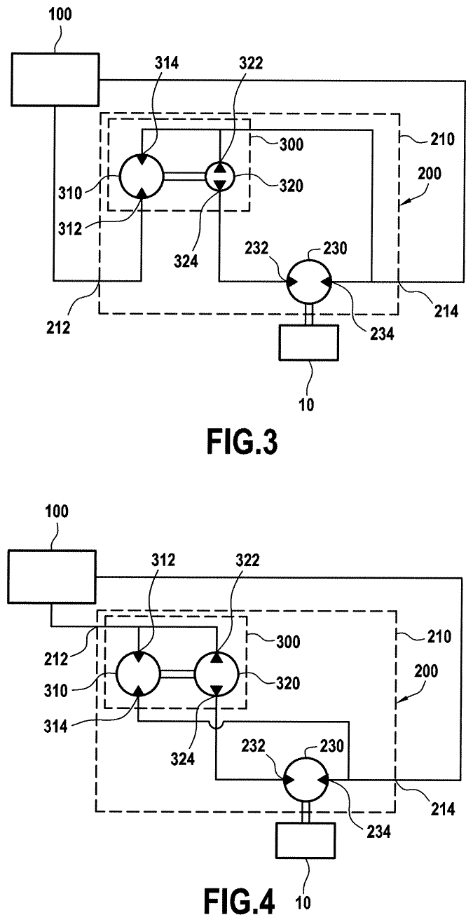

FIGS. 3 and 4 show two exemplary embodiments of the pressure booster 300.

For the casing 210 a first orifice 212 and a second orifice 214 are defined, which form a fluid intake and discharge according to the direction of circulation of the fluid. Similarly, for the primary hydraulic machine 230 a first orifice 232 and a second orifice 234 are defined which form a fluid intake and discharge according to the direction of circulation of the fluid. In the context of the description, for an operation of the primary hydraulic machine 230 as a motor, it will be considered that the first orifice 212 forms a fluid intake, and therefore a high-pressure duct, and that the second orifice 212 forms a fluid discharge, and therefore a low-pressure duct. Unless otherwise specified, it will be considered that the operation described thus corresponds to an operation in traction and in forward motion mode. An orifice in this text denotes an orifice or a terminal suitable for making a hydraulic connection.

The primary hydraulic machine 230 can for example be a rotary machine, typically a hydraulic machine with radial pistons and multilobe cam, or a hydraulic machine with axial pistons. The hydraulic machine can for example be used as a motor for the driving of a member such as a wheel or an axle, a hitched member or a tool.

The primary hydraulic machine 230 can also be a cylinder, the two orifices 232 and 234 are then typically connected to two chambers of the cylinder for the application of antagonistic forces. In such a case, the system then typically comprises means suitable for limiting the pressure in the hydraulic circuit, for example pressure valves with controlled taring. More generally, the hydraulic machine 230 can be any actuator or hydraulic member having a reversible operation. The primary hydraulic machine 230 can more generally be a two-way hydraulic actuator comprising two terminals and suitable for converting the received hydraulic energy into mechanical energy or conversely, and for which the reversal of the pressure difference across its terminals cause a change in the direction of operation.

The pressure booster 300 typically comprises a first hydraulic machine 310 and a second hydraulic machine 320 rotationally secured to one another, and configured in such a way that one has the operation of a pump and the other has the operation of a motor, it being understood that such members are reversible and that a hydraulic motor can operate as a pump, and reciprocally. In the illustrated examples, the a first hydraulic machine 310 has the operation of a motor, and the second hydraulic machine 320 has the operation of a pump. The term “rotationally secured to one another” should here be understood to mean that the first hydraulic machine 310 and the second hydraulic machine 320 are rotationally coupled, and therefore rotate jointly. This rotational coupling can be made for example by coupling the two hydraulic machines to one and the same shaft, or by connecting them via a rigid mechanical connection.

The first hydraulic machine 310 and the second hydraulic machine 320 are typically formed by one and the same hydraulic machine comprising two separate parts.

In the example illustrated on FIG. 3, the first hydraulic machine 310 has a first orifice 312 and a second orifice 314, the first orifice 312 being connected to the first orifice 212 of the casing 210 (i.e. here to the orifice of the casing 210 having the highest pressure), and the second orifice 314 being connected to the second orifice 214 of the casing 210 (i.e. to the orifice of the casing 210 having the lowest pressure). The second hydraulic machine 320 has a first orifice 322 and a second orifice 324, the first orifice 322 being connected to the second orifice 314 of the first hydraulic machine 310 and to the second orifice 214 of the casing 210 (i.e. to the orifice of the casing 210 having the lowest pressure), and the second orifice 324 being connected to the first orifice 232 of the primary hydraulic machine 230, (i.e. its intake, and therefore its orifice having the highest pressure) via ducts fashioned in the casing. In this embodiment, the first hydraulic machine 310 has a displacement C1 greater than the displacement C2 of the second hydraulic machine 320. Such an embodiment is described as a 3-line, shared-return booster. The first hydraulic machine 310 and/or the second hydraulic machine 320 may for example have fixed or variable displacements. By way of example, one can have a fixed displacement and the other a variable displacement, or both can have a fixed displacement, or both can have a variable displacement. The use of at least one variable-displacement hydraulic machine makes it possible to vary the pressure amplification or boost ratio of the first hydraulic machine 310 to the second hydraulic machine 320. The system can then for example comprise a controller suitable for controlling the variation of the displacement ratio and therefore the variation of the pressure boost ratio according to a setpoint or operating conditions.

The first hydraulic machine 310 and the second hydraulic machine 320 are typically identical or similar in all respects and not symmetrical, except optionally for the displacement. The first hydraulic machine 310 and the second hydraulic machine 320 typically each have a single shaft output, these two shaft outputs being mechanically connected.

In operation, the pressure booster 300 is supplied by the hydraulic energy source 100 suitable for delivering a flow, thus making it possible to raise the pressure in the circuit. A high pressure is thus applied to the intake 312 of the first hydraulic machine 310. This latter fulfils a function of rotational driving of the second hydraulic machine 320. The second hydraulic machine is supplied via the discharge of the first hydraulic machine 310. However, due to differences in displacement, the second hydraulic machine 320 will then deliver a higher pressure, that will be described as very high pressure, to supply the primary hydraulic machine 230. In this embodiment, the pressure boost therefore depends in particular on the ratio of the displacements C1 and C2.

More generally, the pressure booster 300 thus makes it possible to draw a flow rate Q1 and a pressure P1 at an orifice of the casing 210, here the first orifice 212 of the casing 210, and deliver a flow rate Q2 and a pressure P2 to the intake of the hydraulic machine 230 (here its first orifice 232), such that Q2<Q1 and P2>P1.

In the example illustrated on FIG. 4, the first orifice 312 of the first hydraulic machine 310 and the first orifice 322 of the second hydraulic machine 320 are both connected to the first orifice 212 of the casing 210 (i.e. here to the orifice of the casing 210 having the highest pressure).

The second orifice 314 of the first hydraulic machine 310 is connected to the second orifice 214 of the casing 210 (i.e. to the orifice of the casing 210 having the lowest pressure).

The second orifice 324 of the second hydraulic machine 320 is connected to the first orifice 232 of the primary hydraulic machine 230, (i.e. its intake, and therefore its orifice having the highest pressure) via ducts fashioned in the casing. Such an embodiment is qualified as a 3-line, shared-supply booster.

In this embodiment, the first hydraulic machine 310 can typically have a displacement C1 equal or substantially equal to the displacement C2 of the second hydraulic machine 320.

In operation, the pressure booster 300 is supplied by the hydraulic energy source 100. A high pressure is thus applied to the intake 312 of the first hydraulic machine 310. This latter fulfils a function of rotationally driving the second hydraulic machine 320. The second hydraulic machine 320 is also supplied by the hydraulic energy source 100; it will therefore fulfil a function of amplification of the pressure.

As for the preceding embodiment, the pressure booster 300 thus makes it possible to draw a flow rate Q1 and a pressure P1 at an orifice of the casing 210, here the first orifice 212 of the casing 210, and deliver a flow rate Q2 and a pressure P2 to the intake of the hydraulic machine 230 (here its first orifice 232), such that Q2<Q1 and P2>P1.

More generally, the pressure booster 300 makes it possible to convert the high pressure at the intake of the casing 210 into a very high pressure at the intake of the primary hydraulic machine 230.

In the system according to the invention, as indicated previously, the connection between the primary hydraulic machine 230 and the second hydraulic machine 320 is formed by ducts fashioned in the casing 210 of the drive member 200. Such a structure thus makes it possible to confine the very high pressure area to a small internal space of the casing 210, and to avoid a boosting of pressure in the whole circuit.

The proposed structure thus makes it possible to boost the pressure supplied to the primary hydraulic machine 230, without requiring any overdimensioning of the different components of the hydraulic circuit.

This function can in particular be implemented intermittently, for example for driving over an obstacle. The pressure booster 300 can then be selectively enabled when conditions are met.

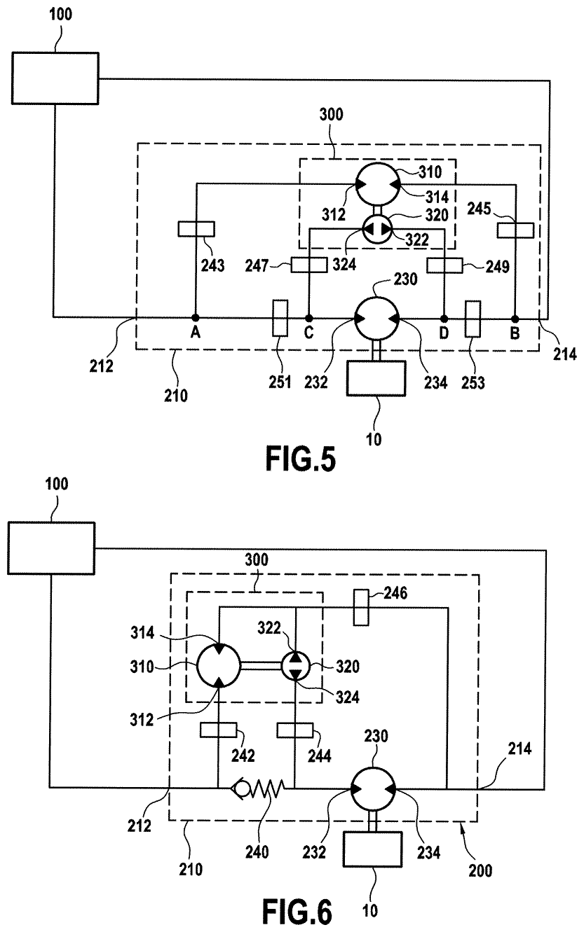

FIG. 5 schematically represents a variant of the invention wherein the pressure booster 300 is embodied by a first hydraulic machine 310 and a second hydraulic machine 320 rotationally secured to one another, wherein the supply and discharge ducts of the first hydraulic machine 310 and the supply and discharge ducts of the second hydraulic machine 320 are, as default, isolated from one another. Such a pressure booster can be referred to as a “4-line booster” to distinguish it from the other variants of pressure booster described which themselves comprise “3 lines”; these include in particular the “3-line with shared supply” booster as shown on FIG. 4 and the “3-line with shared return” pressure booster as on FIGS. 3 and 6 to 9.

In the example illustrated on FIG. 5, valves allow the passage or non-passage of the fluid through the ducts according to whether or not the pressure booster is enabled. This makes it possible to enable or not enable the pressure booster in one direction of rotation or the other, either in traction or in restraint mode (for example for an item of machinery equipped with a system according to the invention).

The first hydraulic machine 310 has a first orifice 312 and a second orifice 314; the first orifice 312 is connected to the duct joining the first orifice 212 of the casing 210 to the first orifice 232 of the primary hydraulic machine 230 at a hydraulic junction A. The second orifice 314 is connected to the duct joining the second orifice 214 of the casing 210 to the second orifice 234 of the primary hydraulic machine 230 at a hydraulic junction B.

The second hydraulic machine 320 has a first orifice 322 and a second orifice 324; the first orifice 322 is connected to the duct joining the second orifice 214 of the casing 210 to the second orifice 234 of the primary hydraulic machine 230 at a hydraulic junction D. The second orifice 324 is connected to the duct joining the first orifice 212 of the casing 210 to the first orifice 232 of the primary hydraulic machine 230 at a hydraulic junction C.

A valve 243 is positioned between the first orifice 312 of the first hydraulic machine 310 and the hydraulic junction A.

A valve 245 is positioned between the second orifice 314 of the first hydraulic machine 310 and the hydraulic junction B.

A valve 247 is positioned between the second orifice 324 of the second hydraulic machine 320 and the hydraulic junction C.

A valve 249 is positioned between the first orifice 322 of the second hydraulic machine 320 and the hydraulic junction D.

A valve 251 is positioned on the duct joining the first orifice 212 of the casing 210 to the first orifice 232 of the primary hydraulic machine 230 between the junction A and the junction C.

A valve 253 is positioned on the duct joining the second orifice 214 of the casing 210 to the second orifice 234 of the primary hydraulic machine 230 between the junction D and the junction B.

Each of these valves 243, 245, 247, 249, 251 and 253 can be controlled to pass from a through state to a non-through state or from a non-through state to a through state. Thus, the valves 243, 245, 247, 249, 251 and 253 make it possible to isolate or not isolate the first hydraulic machine 310 and/or the second hydraulic machine 320 from one another and one and/or the other from the primary hydraulic machine 230.

Note that the system may have a smaller number of valves. Thus, the system comprises the valves 251 and 253, and also at least one pair of valves from among the pairs of valves 243 and 245 on the one hand, and 247 and 249 on the other.

These valves 243, 245, 247, 249, 251 and 253 can be controlled hydraulically or electrically, from the inside or from outside the casing 210.

We will now describe an example of operation in traction mode, in a direction of travel that can be described as forward motion.

An initial situation is considered in which the pressure booster 300 is disabled (for example by the user or the control unit of the system according to sensed data). Thus, the valve 251 and the valve 253 are through. The valves 243, 245, 247 and 249 are non-through.

In this scenario, the first orifice 212 of the casing 210 is supplied by the hydraulic energy source 100 and therefore defines the high-pressure intake, while the second orifice 214 of the casing 210 defines the low-pressure discharge. The primary hydraulic machine 230 has the operation of a motor in traction mode with no pressure boost. Moreover, the fluid does not circulate in the pressure booster 300.

When the pressure booster 300 is enabled (for example by the user or the control unit of the system according to sensed data), the valves 251 and 253 are switched to the non-through configuration whereas the valves 243, 245, 247 and 249 are through.

As previously, the first orifice 212 of the casing 210 is then supplied by the hydraulic energy source 100 and therefore defines the high-pressure intake, while the second orifice 214 of the casing 210 defines the low-pressure discharge. However, in this scenario since the valve 251 is non-through, and the valve 243 is through, the high-pressure fluid, instead of being directed toward the first orifice 232 of the primary hydraulic machine 230, is directed toward the first orifice 312 of the first hydraulic machine 310. The second orifice 214 of the casing 210 being connected to the low pressure and the valve 253 being in a non-through configuration whereas the valve 245 is in a through configuration, the low pressure is set up in the line going from the second orifice 214 of the casing 210 passing through the hydraulic junction B and all the way to the second orifice 314 of the first hydraulic machine 310.

The pressure difference across the terminals of the first hydraulic machine 310 generates a rotational movement of this first hydraulic machine 310. The second hydraulic machine 320, being rotationally secured to the first hydraulic machine 310, will operate as a pump to generate a pressure difference across its terminals in such a way as to generate a very high pressure (i.e. a pressure greater than the pressure supplied by the hydraulic energy source to the first orifice 212 of the casing 210 in the hydraulic line going from the second orifice 324 of the second hydraulic machine 320 to the first orifice 232 of the primary hydraulic machine 230, the valve 247 being in a through state. In the hydraulic line going from the first orifice 322 of the second hydraulic machine 320 to the second orifice 234 of the primary hydraulic machine 230 the low pressure has been set up, the valve 249 which is on this line being in a through state.

The pressure difference across the terminals of the primary hydraulic machine 230 being greater than when the pressure booster is disabled, the member 10 set in rotation by the primary hydraulic machine 230 can exert a higher torque (for example to allow the item of machinery equipped with such a device to be driven over an obstacle).

We will now describe an example of operation in restraint mode, in the same direction of travel as previously described and which can be described as forward motion.

When the pressure booster 300 is disabled (for example by the user or the control unit of the system according to sensed data), the valve 251 and the valve 253 are through. The valves 243, 245, 247 and 249 are non-through.

In this case, the machine being in a restraint mode (for example the kind known as hydrostatic braking) although the machine is in forward motion (for example driven by its inertia) the hydraulic circuit aims to create a resistive torque, opposing the direction of rotation of the member 10. In this scenario the second orifice 214 of the casing 210 is at the high pressure, while the first orifice 212 of the casing 210 is at the low pressure. Due to the restraint, the primary hydraulic machine 230 has the operation of a pump with no boost of pressure due to the pressure booster 300, in which the fluid does not circulate.

When the pressure booster 300 is enabled (for example by the user or the control unit according to the sensed data), the valves 251 and 253 are non-through whereas the valves 243, 245, 247 and 249 are through.

The primary hydraulic machine 230 in restraint mode has the operation of a pump and a very high pressure is set up on the line connecting the second orifice 234 of the primary hydraulic machine 230 to the first orifice 322 of the second hydraulic machine 320, the valve 249 being through and the valve 253 being in a non-through state. The line connecting the first orifice 232 of the primary hydraulic machine 230 to the second orifice 324 of the second hydraulic machine 320 is at low pressure (the valve 247 being in a through state). The pressure difference across the terminals of the second machine 320 causes the latter to operate as a motor. The second machine 320 which is rotationally secured to the first hydraulic machine 310 causes this latter to work as a pump to exert the restraint of the item of machinery equipped with a system according to the invention by setting up a high pressure in the line going from the second orifice 314 of the machine 310, passing through the valve 245 which is in a through state, through the hydraulic function B, through the second orifice 214 of the casing 210 (the valve 253 being in a non-through state) to join the hydraulic energy source 100. The line going from the first orifice 312 of the first hydraulic machine 310 passing through the valve 243 (which is in a through state), through the hydraulic junction A, through the first orifice 212 of the casing 210 and joining the hydraulic energy source 100 being at low pressure.

The system is reversible, and has a similar operation in a reversed direction typically corresponding to an operation in reverse motion, whether in traction or in restraint mode, with the pressure booster 300 engaged or not.

More generally, the invention as proposed has an operation that will be described as 4-quadrant, namely a possible operation along two directions of operation typically corresponding to forward motion and reverse motion, and in traction or restraint mode.

The embodiment described is particularly advantageous due to its structural symmetry which makes it possible to operate interchangeably with the pressure booster 300 according to the invention engaged or disengaged, in restraint and in traction mode, in forward motion and in reverse motion.

FIG. 6 schematically represents a variant of FIG. 3 to which actuators such as valves have been added to control the enabling or non-enabling of the pressure booster 300. As in FIG. 3, here it is a 3-line, shared-return booster.

On this figure, the first orifice 232 of the primary hydraulic machine 230 is connected to the first orifice 212 of the casing 210 via a tared valve 240, which is through in the direction from the first orifice 212 of the casing 210 to the first orifice 232 of the primary hydraulic machine 230 when the pressure at the first orifice 212 of the casing 210 exceeds a taring value.

Note that the tared valve 240 can also be a controlled tared valve, i.e. a pressure valve, the opening of which can be commanded by an external controller, for example a hydraulic, pneumatic controller.

Also shown on this figure are different possible locations for a control valve making it possible to control whether or not the pressure booster 300 is enabled. It will be understood that the different locations indicated can be used individually or combined in one and the same embodiment according to the desired control.

According to a first example, the system comprises a valve 242 positioned between the first orifice 212 of the casing 210 and the first orifice 312 of the first hydraulic machine 310, i.e. upstream of the intake of the hydraulic motor of the pressure booster according to the operation under consideration. Thus, when the valve 242 is non-through, the pressure booster 300 is not supplied and is therefore disengaged. The term “disengaged” should here be understood to mean that the pressure booster 300 is not operational, i.e. in particular that the pressure difference between the two orifices 232 and 234 of the primary hydraulic machine 230 is equal to the pressure difference between the two orifices 212 and 214 of the casing 210, give or take the load losses.

According to a second example, the system comprises a valve 244 positioned between the second orifice 324 of the second hydraulic machine 320 and the first orifice 232 of the primary hydraulic machine 230. When the valve 244 is non-through, the discharge of the second hydraulic machine 320 is closed off, the first hydraulic machine 310 and the second hydraulic machine 320 then have an effective displacement of zero.

According to a third example, the system comprises a valve 246 positioned between the second orifice 314 of the first hydraulic machine 310 and the first orifice 322 of the second hydraulic machine 320 on the one hand, and the second orifice of the casing 214 and the second orifice 234 of the primary hydraulic machine 230 on the other hand. This valve 246 is then typically used jointly with one of the valves 242 and/or 244 described previously. The valve 246 is then through when the pressure booster 300 is engaged. The valve 246 and where applicable one and/or the other of the valves 242 and/or 244 is non-through when the pressure booster 300 is disengaged.

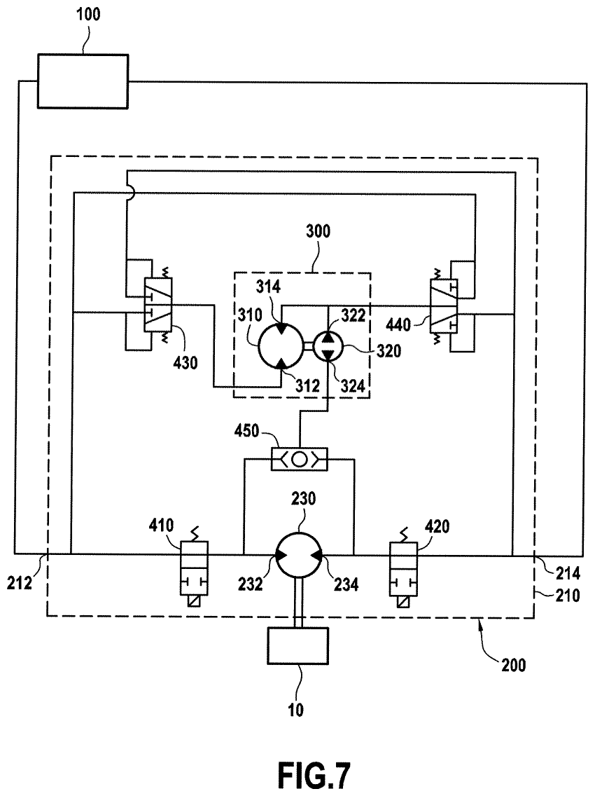

FIG. 7 shows an exemplary embodiment of a system according to an aspect of the invention. This figure shows the different elements allowing an operation of the system in both directions of rotation of the primary hydraulic machine 230, whether it be in traction or restraint mode. The peculiarity and benefit of such a circuit is that it makes it possible to offer the user a so-called 4-quadrant operation with a pressure booster that does not have a symmetrical design. In this exemplary embodiment, the pressure booster 300 is of 3-line, shared-return type similar to that already described with reference to FIG. 3.

In the illustrated example, different control valves are incorporated in such a way as to control the activation or non-activation of the pressure booster 300. These different control valves, which will be described below, may be incorporated into the casing 210 or not.

The control valves can for example be configured in such a way as to activate the pressure booster when the pressure difference between the first orifice 212 and the second orifice 214 of the casing 210 exceeds a threshold value, and to disengage it when the pressure difference between the first orifice 212 and the second orifice 214 of the casing 210 is below said threshold value. Such an engagement type for example corresponds to driving over an obstacle. In a variant, the control valves can for example be configured in such a way as to disengage the pressure booster when a fluid flow rate at the orifice of the casing 210 forming the fluid intake exceeds a threshold flow rate value, which is an indication of travel at high speed. Alternatively or complementarily, the system may comprise a sensor of the rotational speed of the member 10 or of an axle driven by the primary hydraulic machine 230 associated with a controller such as an electronic control unit (ECU) in such a way that the control valves are then controlled to disengage the pressure booster when the speed measured by the sensor exceeds a certain threshold.

The system as shown comprises two circuit shutoff valves 410 and 420, that will be referred to as first circuit shutoff valve 410 and second circuit shutoff valve 420. These valves are typically valves of on/off type, which can be through or not. They can for example be electric valves which are through as default, i.e. in the absence of any control, or which are non-through as default.

The first circuit shutoff valve 410 is positioned between the first orifice 212 of the casing 210 and the first orifice 232 of the primary hydraulic machine 230. The second circuit shutoff valve 420 is positioned between the second orifice 214 of the casing 210 and the second orifice 234 of the primary hydraulic machine 230.

The system also comprises two tared valves or amplifier valves, 430 and 440 respectively. In the illustrated example, these valves 430 and 440 are independent. In a variant, these valves 430 and 440 can be mechanically connected.

The first amplifier valve 430 is typically a valve of slide type, suitable for selectively connecting the first orifice 312 of the first hydraulic machine 310 either to the first orifice 212 of the casing 210, or to the second orifice 214 of the casing 210, typically to the one of said orifices 212 and 214 that has the highest pressure. The first amplifier valve 430 is as default in a non-through configuration. It is tared in such a way that it is only in the through state when the pressure difference between the first orifice 212 of the casing 210 and the second orifice 214 of the casing 210 exceeds a taring value or engagement value.

The second amplifier valve 440 is typically a valve of slide type, suitable for selectively connecting the second orifice 314 of the first hydraulic machine 310 and the first orifice 322 of the second hydraulic machine 320 either to the first orifice 212 of the casing 210, or to the second orifice 214 of the casing 210, typically to the one of said orifices 212 and 214 that has the lowest pressure. The second amplifier valve 440 is as default in a non-through configuration. It is tared in such a way that it is only in the through state when the pressure difference between the first orifice 212 of the casing 210 and the second orifice 214 of the casing 210 exceeds said taring value or engagement value.

The second orifice 324 of the second hydraulic machine 320 is connected to the first orifice 232 and to the second orifice 234 of the primary hydraulic machine 230 by high-pressure selector 450, suitable for connecting the second orifice 324 of the second hydraulic machine 320 to the orifice of the primary machine 230 having the highest pressure.

This structure of the system allows reversible operation, as will be described below.

A description will now follow of a first operating mode of the system, corresponding to a traction mode along a first direction of travel that can be described as forward motion. In this embodiment, the first orifice 212 of the casing 210 is supplied by the hydraulic energy source 100 and therefore defines the high-pressure intake, while the second orifice 214 of the casing 210 defines the low-pressure discharge. The primary hydraulic machine 230 has the operation of a motor. The circuit shutoff valves 410 and 420 are through; the primary hydraulic machine 230 is therefore directly supplied by the hydraulic energy source 100. When the pressure difference between the first orifice 212 of the casing 210 and the second orifice 214 of the casing 210 is less than the taring value or engagement value, the pressure booster 300 is disengaged.

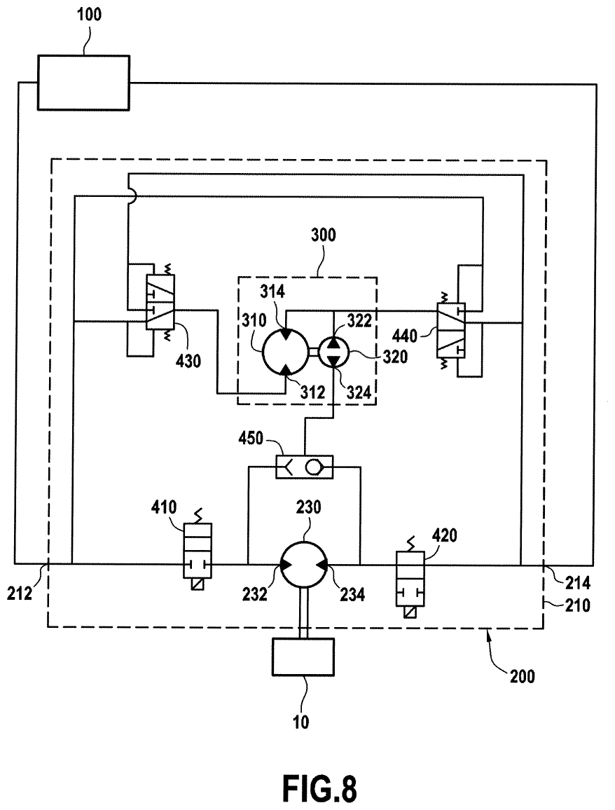

When the pressure difference between the first orifice 212 of the casing 210 and the second orifice 214 of the casing 210 exceeds the taring value, the amplifier valves 430 and 440 are actuated. The first orifice 312 of the first hydraulic machine 310 is then connected to the first orifice 212 of the casing 210, while the second orifice 314 of the first hydraulic machine 310 and the first orifice 322 of the second hydraulic machine 320 are connected to the second orifice 214 of the casing 210. The circuit shutoff valve 410 is then switched in such a way as to no longer be through. This configuration is shown on FIG. 8.

In this configuration, one again finds the operation described with reference to FIG. 3; the high-pressure selector 450 ensures that the pressure delivered by the second hydraulic machine 320 is delivered to the intake of the primary hydraulic machine 230, i.e. here its first orifice 232. The pressure P2 is isolated from the hydraulic circuit due to the switching of the circuit shutoff valve 410 to its non-through configuration.

The circuit shutoff valves 410 and 420 are then controlled to switch to their through configuration when the pressure difference between the first orifice 212 of the casing 210 and the second orifice 214 of the casing 210 once again drops below the taring value or engagement value, or for example when the flow rate at the first orifice 212 of the casing 210 or at the second orifice 214 of the casing 210 exceeds a threshold value, or else when the rotation speed of the primary hydraulic machine 230 exceeds a threshold value, which then disengages the pressure booster 300.

In a situation of operation in the same direction but in a scenario of braking or restraint, the high-pressure and low-pressure branches of the hydraulic circuit are inverted.

The high-pressure branch of the circuit is set up at the second orifice 234 of the primary hydraulic machine 230, which is therefore connected to the second orifice 324 of the second hydraulic machine 320 via the high-pressure selector 450.

If the pressure difference between the first orifice 212 of the casing 210 and the second orifice 214 of the casing 210 is less than the taring value or engagement value, the amplifier valves 430 and 440 are non-through, and the pressure booster is disengaged.

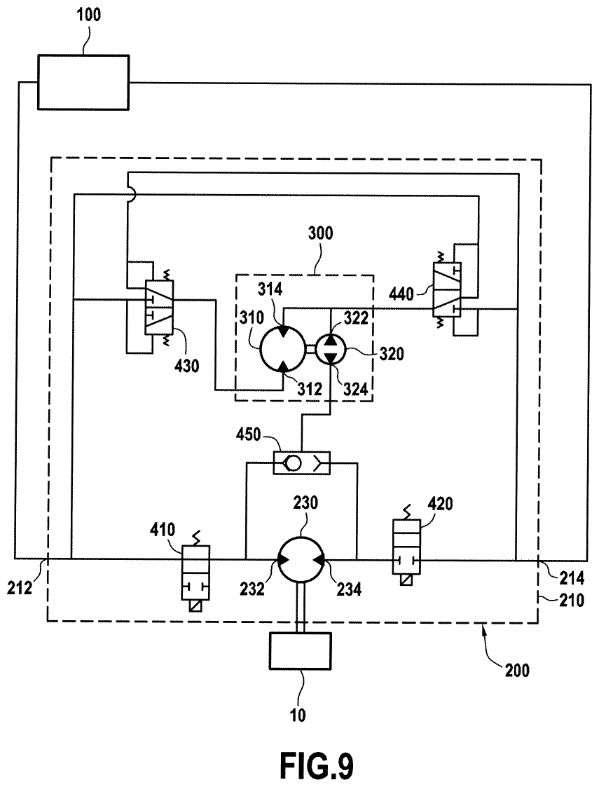

If the pressure difference between the first orifice 212 of the casing 210 and the second orifice 214 of the casing 210 is greater than or equal to the taring value or engagement value, the amplifier valves 430 and 440 are through. The first orifice 312 of the first hydraulic machine 310 is then connected to the second orifice 214 of the casing 210, while the second orifice 314 of the first hydraulic machine 310 and the first orifice 322 of the second hydraulic machine 320 are connected to the first orifice 212 of the casing 210. The circuit shutoff valve 420 is then switched in such a way as to no longer be through. This configuration is shown on FIG. 9.

In this operation, the first hydraulic machine 310 is supplied by the pressure P1 at the second orifice 214 of the casing 210. It drives the second hydraulic machine 320, which delivers a pressure P2 such that P2>P1 at its second orifice 324 due to the ratio between the displacements of these two hydraulic machines 310 and 320. This pressure P2 is applied to the second orifice 234 of the primary hydraulic machine 230, which accentuates the restraint effect. This pressure P2 is isolated from the rest of the hydraulic circuit due to the switching of the circuit shutoff valve 420 to its non-through configuration.

The system as shown is entirely reversible, and can therefore also operate in the reverse direction, for example for driving in reverse motion, either in traction or in restraint mode, with or without engagement of the pressure booster 300.

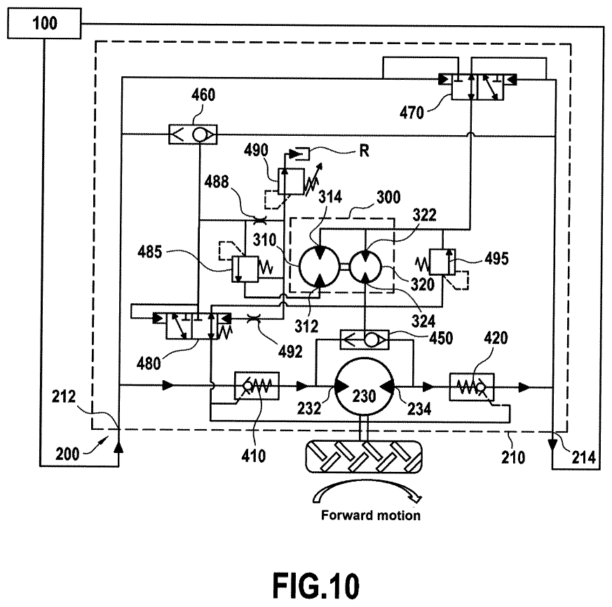

FIG. 10 shows another example of a system according to an aspect of the invention.

In this embodiment, the pressure booster 300 is combined with a plurality of valves and members used to ensure the automatic activation of the pressure booster 300 when the pressure in the hydraulic circuit exceeds a threshold pressure value.

In this embodiment, the pressure booster 300 has a structure similar to that already described with reference to FIG. 3.

In this embodiment, the valves 410 and 420 (shown previously on FIGS. 7, 8 and 9) are replaced by tared check valves with controlled chambers.

The first orifice 212 and the second orifice 214 of the casing 210 are connected in parallel to a high-pressure selector 460 and to a low-pressure selector 470.

The low-pressure selector 470 is connected to the second orifice 314 of the first hydraulic machine 310 and to the first orifice 322 of the second hydraulic machine 320.

The high-pressure selector 460 is connected to a control valve 480, as well as to a sequence valve 485 and to a first restriction 488. The first restriction 488 is connected to a relief valve 490 suitable for releasing pressure when the pressure exceeds a threshold relief value, and is also connected to a hydraulic control line of the sequence valve 485, as well as to a hydraulic control line of the control valve 480 via a second restriction 492.

The sequence valve 485 connects the high-pressure selector 460 to the first orifice 312 of the first hydraulic machine 310 of the pressure booster 300.

The control valve 480 is connected on the one hand to the controlled chambers of the tared check valves 410 and 420, and on the other hand to the second orifice 324 of the second hydraulic machine 320.

The second orifice 324 of the second hydraulic machine 320 is also connected to the high-pressure selector 450 and to a pressure limiter 495. The high-pressure selector 450 is connected to both orifices 232 and 234 of the primary hydraulic machine 230. It is suitable for connecting the second orifice 324 of the second hydraulic machine 320 to the orifice of the primary machine 230 having the highest pressure.

The control valve 480 is configured to selectively connect the controlled chambers of the tared check valves 410 and 420 either to the high-pressure selector 460, or to the high-pressure selector 450 connected to the second orifice 324 of the second hydraulic machine 320. By default, the control valve 480 connects the controlled chambers of the tared check valves 410 and 420 to the second orifice 324 of the second hydraulic machine 320. When the pressure at the high-pressure selector 460 exceeds a certain threshold (determined by the stiffness of the elastic return means of the control valve 480) the value of the pressure at the second restriction 492 on the side of the control chamber 480, this latter switches to its configuration in which it connects the controlled chambers of the tared check valves 410 and 420 to the high-pressure selector 460.

The sequence valve 485 is non-through by default. It becomes through when the difference between the pressure at its intake and the pressure delivered to its control line at the outlet of the first restriction 488 exceeds a threshold sequence value. This threshold sequence value is reached when the relief valve 490 becomes through (because then a flow passes through the first restriction 488, thus creating a pressure difference across its terminals, the lowest pressure being at the terminal connected to the relief valve 490). The relief valve 490 thus determines by its taring (typically by means of a tared spring) the pressure value from which the sequence valve is engaged, and thus the pressure value from which the pressure booster 300 is supplied. The taring of the relief valve 490 can be adjustable or fixed.

A description will now follow of a first operating mode of this system, corresponding to an operating mode in a first direction of operation, with no pressure boost. This operating mode corresponds to the configuration shown on FIG. 10.

The hydraulic energy source 100 delivers a supply pressure P1 to the first orifice 212 of the casing 210.

The high-pressure selector 460 then connects the control valve 480, the first restriction 488 and the sequence valve 485 to the first orifice 212 of the casing 210. The low-pressure selector 470 connects the second orifice 314 of the first hydraulic machine 310 and the first orifice 322 of the second hydraulic machine 320 to the second orifice 214 of the casing 210.

The pressure P1 as considered here is less than the taring pressure of the relief valve 490. The sequence valve 485 is in its non-through configuration.

The control valve 480 is in its default configuration. It connects the controlled chambers of the tared check valves 410 and 420 to the second orifice 324 of the second hydraulic machine 320, to the pressure limiter 495 and to the high-pressure selector 450.

The pressure booster 300 is thus not set in operation.

The pressure P1 delivered by the hydraulic energy source 100 supplies the primary hydraulic machine 230 via its first orifice 232. In addition, the pressure P1 controls the controlled chambers of the tared check valves 410 and 420 via the high-pressure selector 450. The tared check valve 420 is thus through, in such a way as to allow the discharging of the primary hydraulic machine 230 to the second orifice 214 of the casing 210.

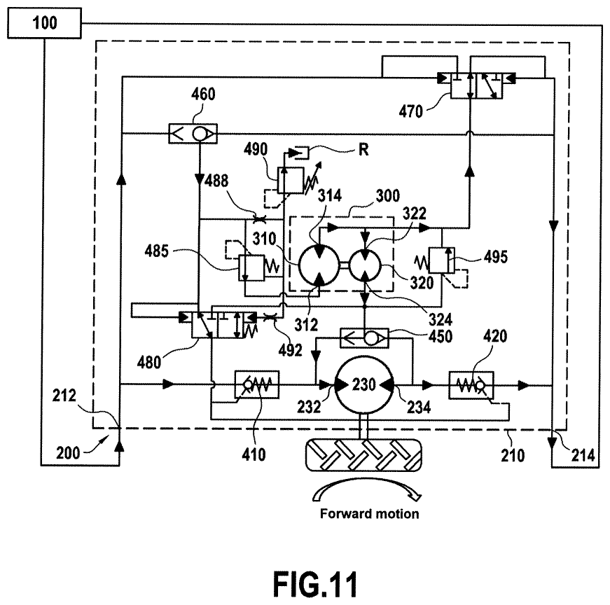

A description will now follow, with reference to FIG. 11, of a second operating mode of this system, corresponding to an operating mode in a first direction of operation, with pressure boosting. Below is a description of the differences compared with the first operating mode.

In this second operating mode, the hydraulic energy source 100 delivers a pressure P1, greater than the taring pressure of the relief valve 490.

The relief valve 490 is thus through, and delivers the excess pressure into the reservoir R; a flow of fluid therefore passes through this valve 490. This flow of fluid generates a load loss in the first restriction 488 and therefore a pressure difference across its terminals (the lowest pressure being at the relief valve 490).

The sequence valve 485 then switches to its through configuration when the difference between the pressure at its intake and its control pressure exceeds the taring value applied by a return element, typically in the order of a few bars, for example 4 bars.

In the same way, the control valve 480 switches to its configuration in which it connects the controlled chambers of the tared check valves 410 and 420 to the high-pressure selector 460 when the pressure difference between the pressure P1 delivered by the hydraulic energy source 100 and the control pressure at the second restriction 492 exceeds a taring value applied by the elastic return means to the control valve 480, typically in the order of a few bars, for example 4 bars.

The pressure booster 300 is supplied via the first orifice 312 of the first hydraulic machine 310. This latter operates as a motor, and rotationally drives the second hydraulic machine 320, the intake 322 of which is connected to the discharge 314 of the first hydraulic machine 310. As already described previously, due to the ratio between the displacements C1 and C2 of the first hydraulic machine 310 and of the second hydraulic machine 320, the pressure delivered by the second hydraulic machine 320 to its second orifice 324 is a pressure P2 such that P2>P1. The pressure limiter 495 defines a maximum pressure P2 max, above which the excess pressure is sent back to the return line of the hydraulic circuit.

The pressure P2 supplies the primary hydraulic machine 230 via the high-pressure selector 450. This latter is in the configuration connecting the second orifice 324 of the second hydraulic machine 320 to the first orifice 232 of the primary hydraulic machine 230 due to the pressure rise, as described previously.

The tared check valve 410 is non-through, its controlled chamber being at the pressure P1 whereas the pressure P2 is applied to the first orifice 232 of the primary hydraulic machine 230.

The primary hydraulic machine 230 discharges the flow rate that supplies it via its second orifice 234 to the second orifice 214, this flow passing through the tared check valve 420 which itself is in the through state due to the pressure P1 applied to its controlled chamber.

It will thus be understood that here, when the pressure delivered by the hydraulic energy source 100 exceeds a threshold pressure value the proposed system automatically switches to an operating mode which activates the pressure booster 300.

When the pressure delivered by the hydraulic energy source 100 decreases and drops below said threshold pressure value again, the system switches to its first operating mode as described previously.

The system as described is reversible. Thus, the two operating modes described with reference to FIGS. 10 and 11 can also be applicable for an operation in the reverse direction; the high-pressure selector 450, the high-pressure selector 460 and the low-pressure selector 470 allow the reversal of the system while keeping an unchanged operating principle.

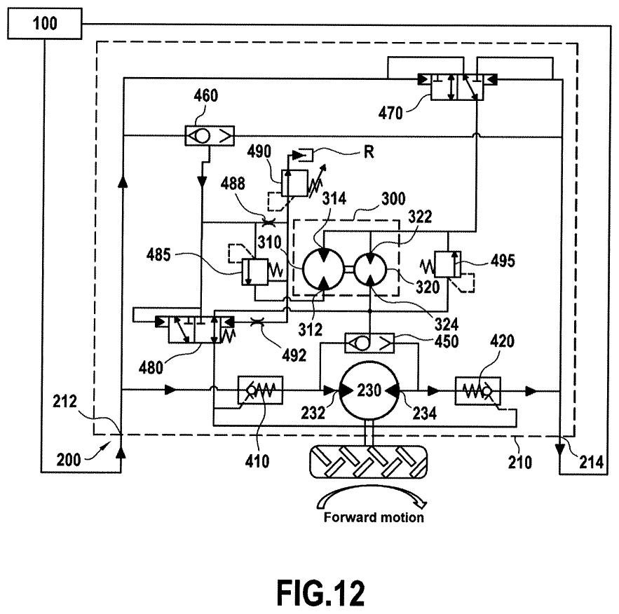

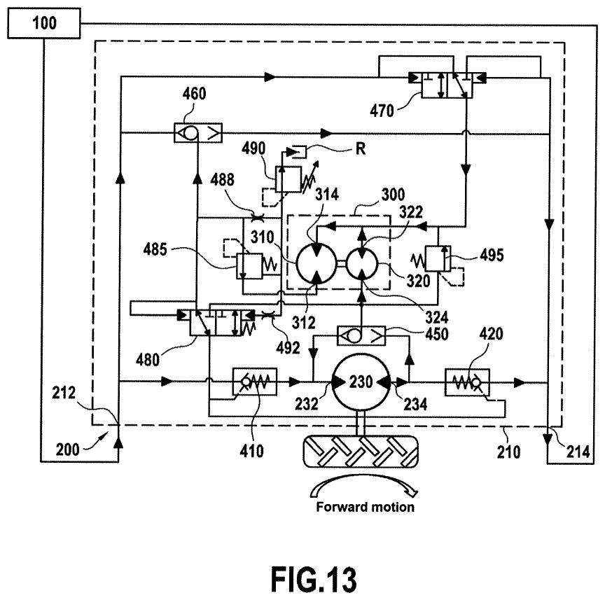

The system as proposed also allows an operation in hydrostatic braking or restraint mode. Such an operation is shown on FIGS. 12 and 13, respectively showing the scenarios in which the pressure booster 300 is not engaged, and in which the pressure booster 300 is engaged.

In FIG. 12 one again finds a similar configuration to that already described with reference to FIG. 10, but in which the high-pressure and low-pressure branches of the hydraulic circuit are inverted. In an operation in restraint or in braking mode, the primary hydraulic machine 230 has the operation of a pump; its intake orifice 232 is at low pressure, while its discharge orifice 234 is at high pressure. Similarly, the first orifice 212 of the casing 210 is at a low pressure, and the second orifice 214 of the casing 214 is at high pressure. The operation of the system by comparison with that already described in relation to FIG. 10 remains unchanged. The high-pressure selector 450, the high-pressure selector 460 and the low-pressure selector 470 ensure the reversal of the hydraulic connections to keep an operation as already described with reference to FIG. 10.

More precisely, in this operating mode, the hydraulic energy source 100 no longer delivers any power. The primary hydraulic machine 230 fulfils a function of hydraulic pump. It delivers a pressurized flow which is applied to the controlled chambers of the tared check valves 410 and 420 via the high-pressure selector 450 in such a way that they are through.

The high-pressure selector 460 and the low-pressure selector 470 ensure that the high-pressure line is connected, particularly to the first restriction 488. As long as the pressure remains less than the taring pressure of the relief valve 490, the pressure booster 300 is disengaged as already described with reference to FIG. 10.

FIG. 13 has a configuration for an operation in restraint mode with the pressure booster 300 activated. As already described with reference to FIG. 11, the activation of the pressure booster occurs as soon as the pressure at the relief valve 490 exceeds its taring pressure, and as soon as the difference at the intake of the sequence valve 485 and the pressure between the first restriction 488 and the second restriction 492 exceeds the taring value defined by the elastic return means of the sequence valve 485.

The sequence valve 485 then becomes through, which allows the setting in rotation of the first hydraulic machine 310 and of the second hydraulic machine 320 of the pressure booster 300 by allowing the circulation of fluid at the first orifice 312 of the first hydraulic machine 310. The valve 480 changes position to connect the highest system pressure P1, to the control chamber of the controlled valves 410 and 420

Transiently, the first hydraulic machine 310 is rotationally driven by suctioning oil from its orifice 312 and by discharging this oil to the orifice 314. The latter, in motor operation, rotationally drives the second hydraulic machine 320 which itself begins to operate as a pump, discharging its oil to the orifice 324. This discharging causes the pressure boost at the second orifice 234, the duct at this orifice having the two hydraulic machines 230 and 320 discharging to it in pump mode. The valve 420, the control chamber of which has been put at the highest system pressure P1 by way of the high-pressure selector 460, closes and becomes non-through. The valve 410 is kept in its through position owing to the control chamber connected to the pressure P1.

Due to the closing of the valve 420, the second hydraulic machine 320 is then supplied via its second orifice 324 by the pressure delivered by the primary hydraulic machine 230. It rotationally drives the first hydraulic machine 310 which, due to its greater displacement, fulfils an additional braking function. This braking will cause a pressure boost at the second orifice 324 of the second hydraulic machine 320 (which here forms its intake), and therefore at the second orifice 234 of the primary hydraulic machine 230 (which here forms its discharge), which amplifies the pressure difference across the terminals of the primary hydraulic machine 230 and therefore the braking or restraint effect.

The fluid delivered by the first hydraulic machine 310 is then conveyed via the high-pressure selector 460 to the second orifice 214 of the casing 210.

Operation in traction or restraint mode thus makes it possible to automatically engage the pressure booster 300 as soon as the pressure difference across the terminals of the primary hydraulic machine 230 exceeds a threshold value.

Just like the operation in traction mode, it will be understood that operation in braking or restraint mode is reversible. Thus, both operating modes described with reference to FIGS. 12 and 13 can also be applicable for an operation in the reverse direction, the high-pressure selector 450, the high-pressure selector 460 and the low-pressure selector 470 allow a reversal of the system while keeping an unchanged operating principle.

In a variant, the relief valve 490 can be an electrically-controlled valve. The taring of the relief valve 490 can thus be controlled and modified, and the opening of the relief valve 490 can be controlled. In a variant one may choose for the taring of the relief valve 490 to be adjustable by a hydraulic or mechanical action.

In a variant, the relief valve 490 can be connected to its output with a 2-position, 2-orifice distributor which makes it possible to obstruct the connection to a low-pressure chamber (casing or reservoir) and prevent any enabling of the pressure booster 300 when this connection is interrupted.

In a variant, a 2-position, 2-orifice distributor can be mounted in parallel with the relief valve 490, in such a way as to make it possible to force the activation of the pressure booster 300 by forcing a leak.

As described previously, the opening of the relief valve 490 controls the activation of the pressure booster 300. Thus, the control of the relief valve 490 for example using an electrical controller makes it possible to control the activation of the pressure booster 300.

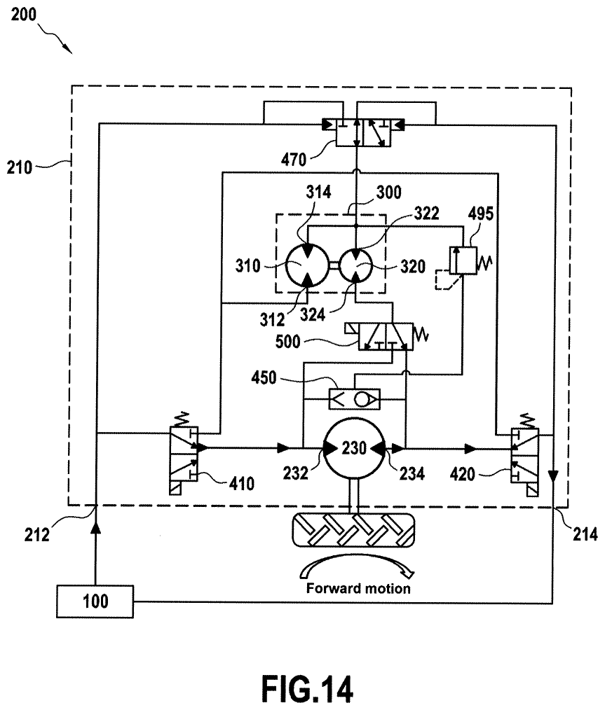

FIG. 14 shows another exemplary embodiment of a system according to an aspect of the invention.

Unlike the variant described previously with reference to FIGS. 10 to 13, this variant is a variant controlled for example using electric controllers or actuators. Thus, the activation or non-activation of the pressure booster 300 can here by chosen by a user or via a controller.

In this embodiment, one again finds the valves 410 and 420 which, here, are electric valves for example. It will be understood that this embodiment is not limiting, and that the valves described as electric valves, in particular the valves 410, 420 and/or 500 can be hydraulically-controlled valves, typically displacement slides.

The orifices 212 and 214 of the casing 210 are each connected on the one hand to the low-pressure selector 470, and on the other hand to one of the valves 410 and 420 respectively.

The valve 410 makes it possible to connect the first orifice 212 of the casing 210 as well as the low-pressure selector 470 either to the first orifice 232 of the primary hydraulic machine 230, or to the first orifice 312 of the first hydraulic machine 310 of the pressure booster 300. In its default configuration, the valve 410 connects the first orifice 212 of the casing 210 either to the first orifice 232 of the primary hydraulic machine 230.

The valve 420 makes it possible to connect the second orifice 214 of the casing 210 as well as the low-pressure selector 470 either to the second orifice 234 of the primary hydraulic machine 230, or to the first orifice 312 of the first hydraulic machine 310 of the pressure booster 300. In its default configuration, the valve 420 connects the second orifice 214 of the casing 210 either to the second orifice 234 of the primary hydraulic machine 230.

The low-pressure selector 470 connects the pressure booster 300, in particular the second orifice 314 of the first hydraulic machine 310 and the first orifice 322 of the second hydraulic machine 320 to the orifice from among the first orifice of the casing 212 and the second orifice of the casing 214 having the lowest pressure. The low-pressure selector 470 is also connected to a pressure limiter 495 suitable for fulling a pressure-limiting function in the circuit. The two orifices 232 and 234 of the primary hydraulic machine 230 are connected to the pressure limiter 495 via a high-pressure selector 450 which makes it possible to fulfil a safety function in the very high-pressure branch.

A selecting slide 500 makes it possible to connect the second orifice 324 of the second hydraulic machine 320 either to the first orifice 232 or to the second orifice 234 of the primary hydraulic machine 230, which thus makes it possible to select the terminal of the primary hydraulic machine 230, the pressure of which one wishes to boost.

A description will now follow of a first operating mode with reference to FIG. 14, for example corresponding to an operation in traction and forward motion mode, with no activation of the pressure booster 300.

The hydraulic energy source 100 delivers a supply pressure P1 to the first orifice 212 of the casing 210.

The valve 410 and the valve 420 are in their default configuration. The pressure P1 thus supplies the first orifice 232 of the primary hydraulic machine 230. The fluid at the discharge 234 of the primary hydraulic machine 230 passes through the valve 420 to reach the second orifice 214 of the casing 210.

The pressure booster 300 is connected to the second orifice 214 of the casing 210 and is not supplied. The primary hydraulic machine 230 is thus supplied directly by the hydraulic energy source 100.

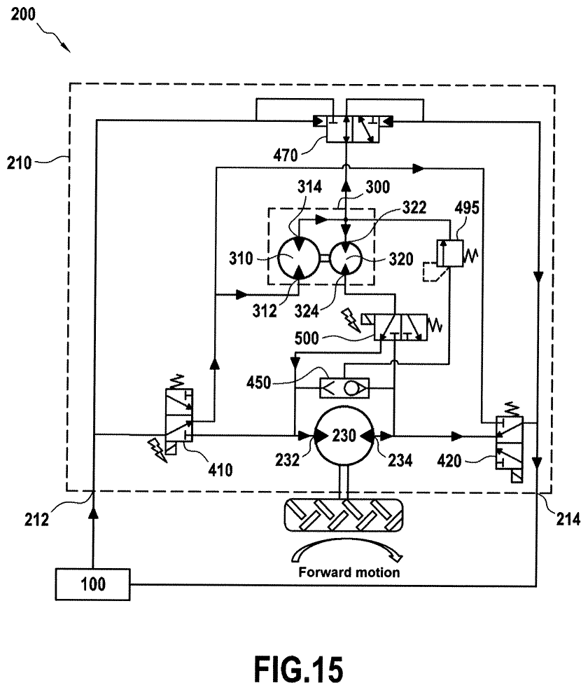

A description will now follow of a second operating mode with reference to FIG. 15, corresponding for example to an operation in traction and in forward motion mode, with activation of the pressure booster 300.

In this operating mode, the control of the valve 410 is enabled. The pressure P1 delivered by the hydraulic energy source 100 thus supplies the first orifice 312 of the first hydraulic machine 310. This latter has the operation of a motor, and rotationally drives the second hydraulic machine 320. This latter is supplied via the discharge of the first hydraulic machine 320, and due to the ratio of the displacements, can deliver a pressure P2>P1.

The pressure P2 is applied to the first orifice 232 of the primary hydraulic machine 230 via the selecting slide 500, the controller of which is actuated. The discharging of the primary hydraulic machine 230 passes through its second orifice 234, and via the valve 420. The excess fluid coming from the second orifice 314 of the first hydraulic machine 310 of the pressure booster 300 through the circuit passes through the low-pressure selector 470 to reach the second orifice 214 of the casing 210.

It will thus be understood that the engagement of the pressure booster is done by the enabling of the valve 410. Conversely, the pressure booster 300 can be disengaged by ceasing to control the valve 410.

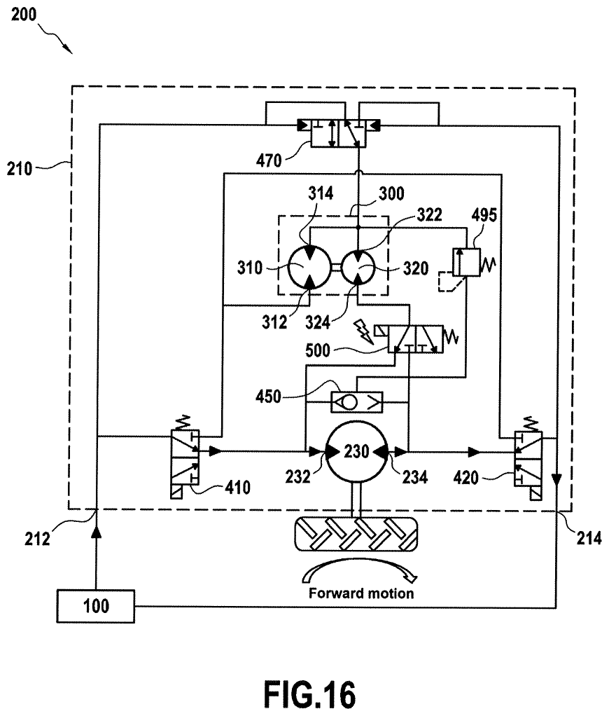

The system described can also fulfil a function of restraint or braking. This operation is detailed with reference to FIG. 16.

In such an operation, the primary hydraulic machine 230 is rotationally driven; it therefore has the operation of a pump. It delivers a pressure P1 to its second orifice 234, which is discharged via the valve 420 by the second orifice 214 of the casing 210.

The selecting slide 500 is actuated in such a way that the orifice 324 of the pressure booster is connected to the orifice 232 of the primary hydraulic machine in such a way that the pump part of the pressure booster outputs to the orifice 232 through which the primary hydraulic machine 230 is supplied.

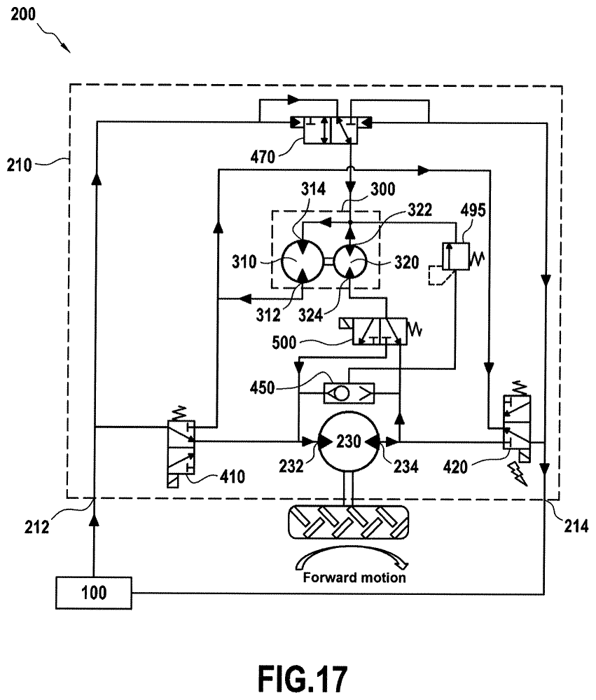

For an operation in restraint mode, the pressure-boosting function can be engaged by controlling the valve 420 and by bringing the selecting slide 500 into its default configuration. Such a configuration is shown on FIG. 17.

The valve 420 thus closes off the discharge through the second orifice 234 of the primary hydraulic machine 230. The flow passes through the selecting slide 500 to supply the second hydraulic machine 320 through the second orifice 324 of the second hydraulic machine 320, which operates as a motor and rotationally drives the first hydraulic machine 310. The first hydraulic machine 310 then operates as a pump, and due to the difference in displacement compared with the second hydraulic machine 320, amplifies the pressure at the orifice 324 of the second hydraulic machine 320, and therefore at the discharge at the orifice 234 of the primary hydraulic machine 230. This pressure boost amplifies the pressure difference across the terminals of the primary hydraulic machine 230, and therefore amplifies the braking or restraining torque.

As previously, the controlling of the valve 420 makes it possible to switch to an operating mode with no pressure boost.

The system as proposed is reversible, either in traction or in restraint mode. The operation is similar to the operation described with reference to FIGS. 14 to 17, with inversion of the high-pressure and low-pressure branches at the orifices 212 and 214 of the casing 210.

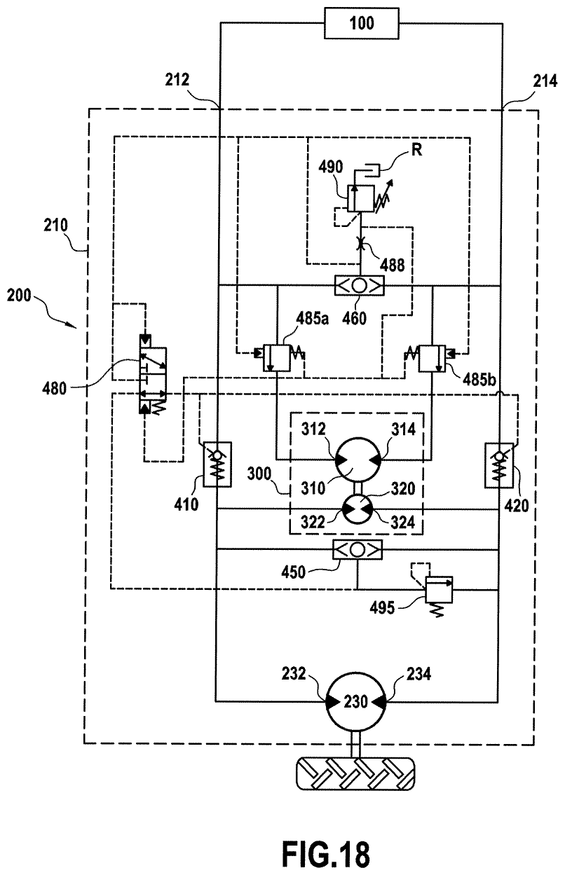

FIG. 18 shows another embodiment of a system according to an aspect of the invention.

In this embodiment one finds different elements already described with reference in particular to FIGS. 10 to 13.

In this embodiment, the pressure booster 300 is of 4-line type, as already described in particular with reference to FIG. 5.

This 4-line pressure-boosting structure 300 requires the duplication of the sequence valve 485. Thus, two sequence valves 485a and 485b are respectively connected to the first orifice 312 and to the second orifice 314 of the first hydraulic machine 310, these two sequence valves 485a and 485b having an identical operation to the sequence valve 485 described previously. Both the sequence valves 485a and 485b typically have one and the same taring. This taring can be fixed, or can be modulated by means of a controller, for example an electrical controller.

The operation is essentially similar to that already described with reference in particular to FIGS. 10 to 13.

When the pressure delivered by the hydraulic energy source 100 is less than the taring pressure of the relief valve 490, both the sequence valves 485a and 485b are non-through, and the pressure booster 300 is therefore not activated.

The primary hydraulic machine 230 is supplied via the valves 410 and 420 which are through, either due to the direction of circulation of the fluid, or due to the controlling of their controlled chambers.

When the pressure delivered by the hydraulic energy source 100 is greater than the taring pressure of the relief valve 490, this latter becomes through and discharges into the reservoir R.

The opening of the relief valve 490 causes the passage of a flow through the restriction 488 thus creating a load loss generating a pressure difference across its terminals; the pressure downstream of the restriction which is the lowest allows the opening of the sequence valves 485a and 485b which are then through, in such a way as to allow the supply and discharge of fluid by the first hydraulic machine 310 of the pressure booster 300. As already described previously, the first hydraulic machine 310 then operates as a motor to drive the second hydraulic machine 320 which operates as a pump, and which can deliver a pressure P2>P1 due to the ratio of the displacements of the first hydraulic machine 310 to the second hydraulic machine 320. The pressure P2 is then delivered to the primary hydraulic machine 230.

The operation in braking or restraint mode is also similar to that already described with reference in particular to FIGS. 12 and 13, with the exception that the two sequence valves 485a and 485b are controlled simultaneously.

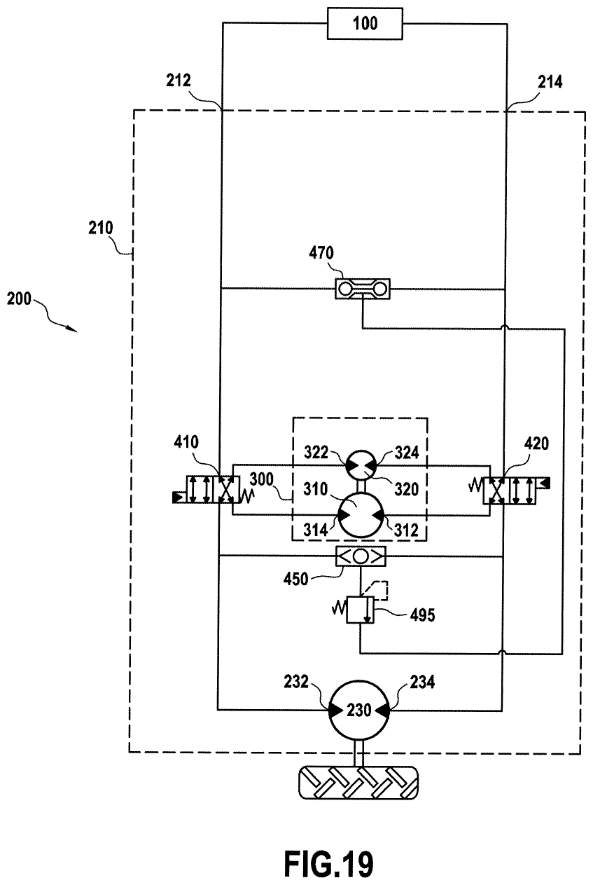

FIG. 19 shows another embodiment of a system according to an aspect of the invention.

This variant is a controlled variant, with a pressure booster 300 of 4-line type.

In the same way as for FIGS. 14 to 17, in this embodiment, one finds again the valves 410 and 420 which are here electric valves for example, and which make it possible to connect the primary hydraulic machine 230 either to the hydraulic energy source 100, or to the pressure booster 300.

The system can thus isolate the pressure booster 300, for example by positioning it in a closed loop so that the pressure booster 300 is in a freewheel configuration.

The valves 410 and 420 can be controlled in such a way that the hydraulic energy source 100 supplies the first hydraulic machine 310 at a pressure P1. This latter rotationally drives the second hydraulic machine 320, and discharges a low pressure to the hydraulic energy source 100. The second hydraulic machine 320 delivers a pressure P2>P1 due to the ratio of the displacements of the first hydraulic machine 310 and of the second hydraulic machine 320, which supplies the primary hydraulic machine 230. The second hydraulic machine 320 then forms a closed circuit with the primary hydraulic machine 230; the very high pressure P2 is thus confined in the casing 210.

The proposed system can also have an operation in restraint or in braking mode, with or without activation of the pressure booster 300 via the controlling of the valves 410 and 420, in particular in a similar way to the embodiment described with reference to FIGS. 16 and 17.

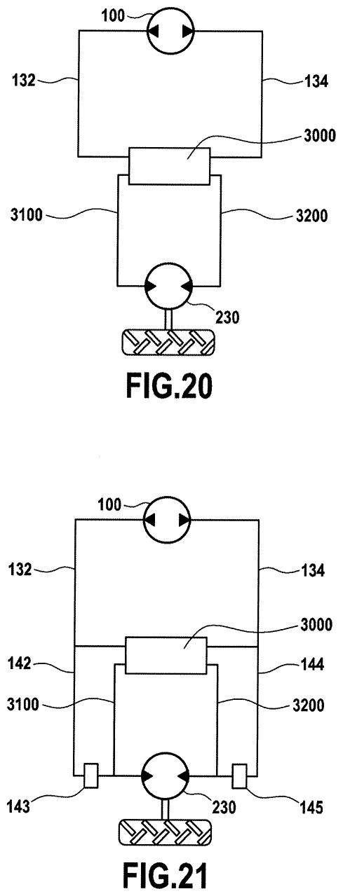

FIG. 20 schematically represents an example of a hydraulic circuit or hydraulic system according to an aspect of the invention.

On this figure one finds again a hydraulic energy source 100 and the hydraulic actuator 230, here shown as being a drive member for a wheel. It will be understood that this embodiment is not limiting, and that the hydraulic actuator 230 can be any hydraulic member, particularly one or more rotational or translational drive members such as two-way hydraulic cylinders.

The hydraulic energy source 100 is suitable for delivering a pressure to the hydraulic circuit. It may for example comprise a source of flow 100 as described previously, for example a hydraulic pump in an open-loop circuit or in a closed-loop circuit, or a hydraulic accumulator.

The block 3000 denotes a pressure-adapting module.

The pressure-adapting module 3000 is suitable for modifying the pressure difference across the terminals of the hydraulic actuator 230 in such a way that the pressure difference across the terminals of the hydraulic actuator 230 is different from the pressure difference across the terminals of the hydraulic energy source 100.

The pressure-adapting module 3000 can thus be a pressure booster, adapted in such a way that the pressure difference across the terminals of the hydraulic actuator 230 is greater than the pressure difference across the terminals of the hydraulic energy source 100.

Conversely, the pressure-adapting module 3000 can thus be a pressure reducer, adapted in such a way that the pressure difference across the terminals of the hydraulic actuator 230 is less than the pressure difference across the terminals of the hydraulic energy source 100.

The pressure-adapting module 3000 typically comprises a pressure booster 300 as described previously, or of any other suitable architecture or structure, and also where applicable an assembly of valves, flaps, slides and hydraulic components suitable for providing control of the circuit.

The pressure-adapting module 3000 and the hydraulic actuator 230 typically define a drive member 200 as described previously.

The pressure-adapting module 3000 and the hydraulic actuator 230 are typically housed in one and the same casing 210 as described previously.

A description will now follow of the hydraulic ducts or lines connecting these elements.

The circuit as shown comprises
a first supply line 132 connecting a first terminal of the hydraulic energy source 100 to a first terminal of the pressure-adapting module 3000,
a second supply line 134 connecting a second terminal of the hydraulic energy source 100 to a second terminal of the pressure-adapting module 3000,
a first adapting line 3100 connecting the pressure-adapting module 3000 to one of the terminals of the hydraulic actuator 230
a second adapting line 3200 connecting the pressure-adapting module 3000 to the other terminal of the hydraulic actuator 230.

In this embodiment, the first supply line, the second supply line, the first adapting line and the second adapting line are separate. The term “separate” should here be understood to mean that the lines are not fluidly connected to one another, and can therefore be at separate pressures.

In the circuit as proposed, considering a first operating mode, the hydraulic energy source 100 thus supplies the pressure-adapting module 3000, and this latter then supplies the hydraulic actuator 230. The direction of operation of the circuit can be reversed in order to drive the hydraulic actuator 230 in two opposing directions.

In addition, since the different hydraulic components are typically reversible, the circuit can have an operation in restraint mode. In such an operating mode, the hydraulic actuator 230 delivers a hydraulic energy, and then supplies the hydraulic energy source 100 via the pressure-adapting module 3000. The pressure-adapting module 3000 amplifies the pressure difference across the terminals of the hydraulic actuator 230 in such a way as to amplify the restraining effect, and does so whatever the direction of operation.

Such a circuit thus makes it possible to embody an operation of 4-quadrant type as described previously.

The circuit as proposed can thus have:
a first operating mode, wherein the hydraulic actuator 230 is supplied in such a way as to deliver a mechanical power along a first direction of operation,
a second operating mode, wherein the hydraulic actuator 230 delivers a hydraulic power along the first direction of operation,
a third operating mode, wherein the hydraulic actuator 230 is supplied in such a way as to deliver a mechanical power along a second direction of operation opposed to the first direction of operation, and
a fourth operating mode, wherein the hydraulic actuator 230 delivers a hydraulic power along the second direction of operation.

FIG. 21 schematically represents a variant of the circuit already described with reference to FIG. 20.

In this embodiment, the circuit comprises:
a first bypass line 142 connecting a first terminal of the hydraulic energy source 100 to the first terminal of the hydraulic actuator 230, and
a second bypass line 144 connecting a second terminal of the hydraulic energy source 100 to the second terminal of the hydraulic actuator 230.

The first bypass line 142 and second bypass line 144 are typically provided with closing means suitable for selectively closing off said first bypass line 142 and second bypass line 144. In the illustrated example, these closing means are denoted by the references 143 and 145 respectively.

The bypass lines 142 and 144 thus make it possible to connect the hydraulic actuator 230 directly to the hydraulic energy source 100 by circumventing the pressure-adapting module 3000.

In the embodiments shown on FIGS. 20 and 21 one again finds the different elements already described with reference to the preceding figures.

The system as shown in the different examples thus makes it possible to boost or increase the pressure across the terminals of the primary hydraulic machine 230 without requiring an overdimensioning of the hydraulic circuit or a boosting of the pressure in the circuit as a whole. The pressure booster 300 as shown makes it possible to obtain a pressure difference between the two orifices 232 and 234 of the primary hydraulic machine 230 which is greater than the pressure difference between the two orifices 212 and 214 of the casing 210.

Such a local amplification of the pressure in the circuit thus makes it possible to obtain the following different advantages.

The primary hydraulic machine 230 can have a smaller displacement for one and the same delivered torque, without it being necessary to dimension the whole hydraulic circuit to be subjected to a higher pressure. The gradability is therefore increased with no overdimensioning of the circuit.

To obtain one and the same pressure and with a primary hydraulic machine of a given displacement, the hydraulic energy source 100 can then be underdimensioned by comparison with a circuit without any pressure booster 300.

Furthermore, the use of a primary hydraulic machine 230 as motor with a reduced displacement has a beneficial impact in terms of efficiency, whether or not the pressure-boosting function is engaged.

The system as proposed can for example be used in an item of machinery, a vehicle, an item of building site machinery, an item of agricultural machinery, or any other item of equipment that can be equipped with a hydraulic drive member as proposed.

For example, such an item of machinery can be equipped with such a system for all or part of the mover members, for example at each wheel, or on one or more axles for driving several wheels of one and the same axle with a single system, for example the rear axle only, the front axle only, or else at each of the wheels of the front axle or on each of the wheels of the rear axle.

Such an item of machinery can have a circuit allowing the automatic engagement of the pressure booster on the moving members or wheels that need extra torque. This automatic enabling can for example be controlled by an electronic control unit, which can for example determine the enabling on the basis of data sensed by the machine, or arise from the design of the hydraulic machine which allows it via an appropriate hydraulic circuit.

Such an item of machinery can have a circuit allowing the commanded engagement of the pressure booster on the wheels which need extra torque, this command being given by the user.

By considering a machine or an item of machinery comprising several drive members according to the invention, the enabling of the different drive members can be done independently or combined to engage the pressure boosting on all the drive members of one and the same part of the machine.

Although this invention has been described with reference to specific exemplary embodiments, it is obvious that modifications and changes may be made to these examples without departing from the general scope of the invention as defined by the claims. In particular, individual features of the different embodiments illustrated/mentioned may be combined in additional embodiments. Consequently, the description and drawings must be considered in an illustrative sense rather than a restrictive one.

It is also obvious that all the features described with reference to a method are transposable, alone or in combination, to a device, and conversely, all the features described with reference to a device are transposable, alone or in combination, to a method.

1. A hydraulic circuit for driving a two-way hydraulic actuator having two terminals, said circuit comprising:
a hydraulic energy source suitable for delivering a flow through the hydraulic circuit,
a hydraulic actuator,
a pressure-adapting module,
a first supply line connecting a first terminal of the hydraulic energy source to a first port of the pressure-adapting module,
a second supply line connecting a second terminal of the hydraulic energy source to a second port of the pressure-adapting module,
a first adapting line connecting the pressure-adapting module to a first terminal of the hydraulic actuator,
a second adapting line connecting the pressure-adapting module to the other terminal of the hydraulic actuator,
the pressure-adapting module being configured for modifying the pressure difference across the terminals of the hydraulic actuator in such a way that the pressure difference across the terminals of the hydraulic actuator is different from the pressure difference across the terminals of the hydraulic energy source.

2. The circuit as claimed in claim 1, wherein the first supply line, the second supply line, the first adapting line and the second adapting line are separate.

3. The circuit as claimed in claim 1, wherein said hydraulic circuit is a closed-loop hydraulic circuit.

4. The circuit as claimed in claim 1, further comprising a first bypass line connecting a first terminal of the energy source to the first terminal of the hydraulic actuator, and a second bypass line connecting a second terminal of the hydraulic energy source the second terminal of the hydraulic actuator,
said first bypass line and second bypass line being equipped with closing means suitable for selectively closing off said first bypass line and second bypass line.

5. The circuit as claimed in claim 1 , wherein the pressure-adapting module is configured for allowing the reduction of the flow rate traversing the hydraulic actuator in such a way that the flow rate traversing the hydraulic actuator is less than the flow rate supplied by the hydraulic energy source.

6. The circuit as claimed in claim 1, wherein the pressure-adapting module is configured for allowing the increasing of the flow rate traversing the hydraulic actuator in such a way that the flow rate traversing the hydraulic actuator is greater than the flow rate supplied by the hydraulic energy source.

7. The circuit as claimed in claim 1, wherein the pressure-adapting module comprises a pressure adapter comprising a first hydraulic machine and a second hydraulic machine rotationally secured to one another, said first and second hydraulic machines, being configured such that one has the operation of a pump and the other has the operation of a motor.

8. The circuit as claimed in claim 7, wherein the pressure-adapting module comprises a single pressure adapter.

9. The circuit as claimed in one of claims 7 or 8, wherein
the first hydraulic machine has a first terminal connected to the first terminal of the hydraulic energy source, and a second terminal connected to the second terminal of the hydraulic energy source,
the second hydraulic machine has a first terminal connected to the first terminal of the hydraulic actuator, and a second terminal connected to the second terminal of the hydraulic actuator.

10. The circuit as claimed in one of claims 7 or 8, wherein
the first hydraulic machine has a first terminal and a second terminal,
the second hydraulic machine has a first terminal and a second terminal,
the first terminal of the first hydraulic machine is connected to the first terminal of the hydraulic energy source,
the second terminal of the second hydraulic machine is connected to the first terminal of the hydraulic actuator,
the second terminal of the first hydraulic machine is connected to the first terminal of the second hydraulic machine, and to the second terminal of the hydraulic energy source.

11. The circuit as claimed in claim 10, wherein the second terminal of the first hydraulic machine is connected to the first terminal of the second hydraulic machine, and to the first terminal and to the second terminal of the hydraulic energy source via a low-pressure selector, the low-pressure selector being typically housed in a casing of the pressure-adapting module.

12. The circuit as claimed in claim 10, wherein the second terminal of the second hydraulic machine is connected to the first terminal and to the second terminal of the hydraulic actuator via a high-pressure selector, the high-pressure selector being typically housed in a casing of the pressure-adapting module.

13. The circuit as claimed in claim 1, suitable for having:
a first operating mode, wherein the hydraulic actuator is supplied in such a way as to deliver a mechanical power along a first direction of operation,
a second operating mode, wherein the hydraulic actuator delivers a hydraulic power along the first direction of operation,
a third operating mode, wherein the hydraulic actuator is supplied in such a way as to deliver a mechanical power along a second direction of operation opposed to the first direction of operation,
a fourth operating mode, wherein the hydraulic actuator delivers a hydraulic power along the second direction of operation.

14. The circuit as claimed in claim 1, wherein the hydraulic actuator is an actuator configured for transforming hydraulic energy into mechanical energy or conversely, and configured in such a way that a reversal of the pressure difference across its terminals causes a change of direction of actuation.

15. The circuit as claimed in claim 1, wherein the pressure booster is configured to be engaged when the highest of the two pressures between the first supply line and the second supply line exceeds a threshold value.
